(19) United States
(12) Patent Application Publication
(10) Pub. No.: US 2009/0192989 A1
(43) Pub. Date: Jul. 30, 2009

(54) SOCIAL CONTACT SERVICE SYSTEM FOR INTERNET CONNECTED DIGITAL PHOTO

(75) Inventors: Ah-Jee WANG, Taipei City (TW); Chi-Chou LIN, Taipei City (TW)

Correspondence Address: Muncy, Geissler, Olds & Lowe, PLLC, P.O. BOX 1364, FAIRFAX, VA, 22038-1364, US

(73) Assignee: D-Link Corporation

(21) Appl. No.: 12/062,242

(22) Filed: Apr. 3, 2008

(30) Foreign Application Priority Data
Jan. 25, 2008 (TW) 97102898

(51) Int. Cl. G06F 7/06; G06F 17/30

(52) U.S. Cl. 707/3; 707/E17.014

(57) ABSTRACT

A social contact service system for internet connected digital photos enables internet connected digital photo frames to be a social contact group. Via the social contact service system, any one of grouping internet connected internet connected digital photo frames would upload updated digital information to notify the members of the social contact group, and download another updated digital information from other members of the social contact group. Furthermore, with the desktop utility of a computer, other portal service system and an internet connected digital photo frame with control management, the digital contents in the social contact service system may be integrated and managed.

### BACKGROUND OF THE INVENTION

1. Field of the Invention

The present invention relates to a social contact service system of internet connected digital photos, and more specifically, to social contact service system of grouping internet connected digital photos.

2. Background of the Related Art

Digital photo frames have been popular small and middle-size display products in the recent years. In a research, the users of digital photo frames tend to directly view and share photos on a display apparatus. Such a behavior model of customer leads the design tendency of internet connected digital photo frames. Generally, the typical digital photo frame is equipped with a LCD screen for displaying photos in various formats, the function of linking network to upload and download photo files and simple management.

However, similar to the development of prior contents in the internet, the unidirectional communication of the digital photo frames and the internet does not satisfy users' requirement. For example, nowadays most of the users linking the internet to online browse their friends or relatives' web logs or digital contents by themselves and take a look whether there is any update information. Sometimes those whose information is seldom updated are easily forgotten by people. Furthermore, the users have no time to browse all of their favorite digital contents. Besides improvement on the users' hardware, portal websites gradually develop customized digital contents. For example, some websites of Web 2.0 generate bulletins that the users can subscribe. Thus, it is important for the internet service provider to develop the websites capable of providing users to friendly and flexible content interaction.

### SUMMARY OF THE INVENTION

The present invention provides the customers of digital products with a social contact service system for internet connected digital photos. The social contact service system may integrate the maintenance service and the social contact service of the digital products.

Further, the present invention provides a social contact service system for internet connected digital photos that are provided by grouping digital photo frames. The internet connected digital photo frames become the group via a service portal website for a digital photo group, and build a social contact co-generation system, together with the service portal website for a digital photo group. Real time sharing is carried out by the social contact co-generation system to provide a diversified and simple management mechanism.

Accordingly, one of embodiments of the present invention provides a social contact service system of internet connected digital photos including a managing module coupling with a registration/authentication module, a notification module, a portal station database and a user-setting database. The improvement includes: the registration/authentication module receiving a registration and a customized content settings from a user, and transmitting the registration and the customized content settings to the managing module; the managing module searching for the registration in the user-setting database to determine whether retrieves an updated information of a group containing the user, and searching for the customized content settings in the portal station database to retrieve, in the portal station database, an updated content associated with the customized content settings; and the notification module transmitting the updated information and the updated content from the managing module to the user. The managing module provides a management mechanism on information assignment to manage the updating of digital information, the downloading digital information to which internet connected digital photo frames are, the assignment of portal station information, the timing arrangement, management and customization of portal station information, the timely updating work, and so on. The managing module also provides simultaneously process and the application utilities of a computer, such as widget managing utilities provided by Yahoo or Google, dashboard managing utilities by a commercial operating system MAC, gadget managing utilities by Microsoft Corporation under the trademark Vista or the combinations thereof. The managing module also cooperates with an internet connected digital photo frame capable of control management. The managing module also exchanges advertisement information with an advertisement platform and assign the advertisement information. One of embodiments of the present invention provides a social contact co-generation system including various internet connected digital photo frames together with the social contact service system of digital photos aforementioned. When linking to the social contact service system of digital photos, any one of the digital photo frames may receive the updated information from the belonging group and download real time information at preset time. The real time information may and not limited to weather forecast, finances management, stock market news, flash news, top products, web photos, video and audio information, advertisement for sales promotion, or the combination thereof.

These and other aspects, features and advantages of the present invention can be further understood from the accompanying drawings and description of preferred embodiments.

### BRIEF DESCRIPTION OF THE DRAWINGS

FIG. 1 is a schematic diagram illustrating a relationship of an internet connected digital photo frame and the group thereof in accordance with one embodiment of the present invention.

FIG. 2 is a schematic diagram illustrating a social contact service system of a portal website for a digital photo group in accordance with the present invention.

### DETAILED DESCRIPTION OF THE INVENTION

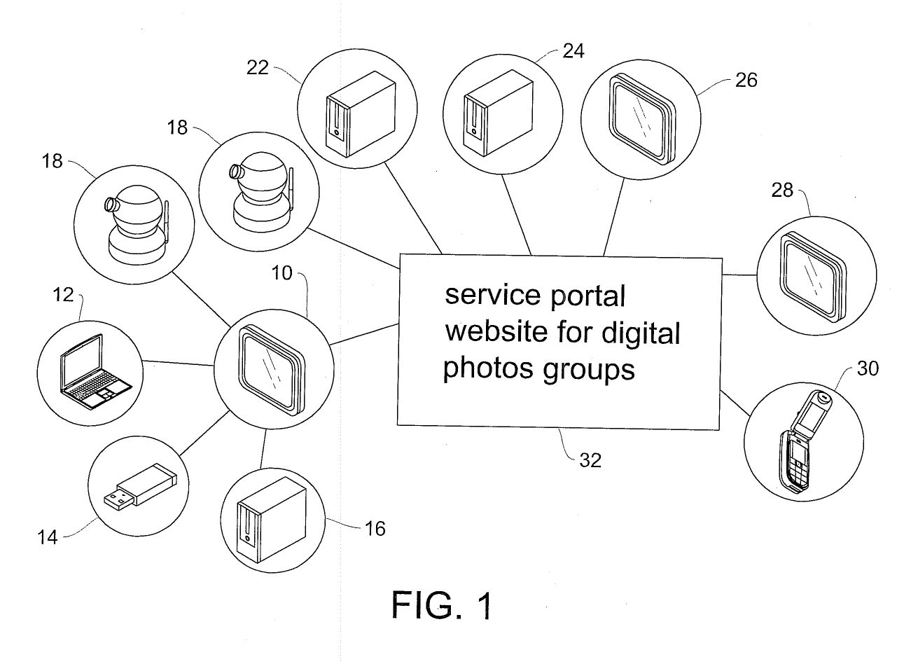

FIG. 1 is a schematic diagram illustrating a relationship of an internet connected digital photo frame and the group thereof in accordance with one embodiment of the present invention. At a user's local site, an internet connected digital photo frame 10 is coupled with an apparatus that may provide various files of digital photos, such as a portable computer 12, universal plug and play 14 or desktop 16, an IP camera 18 and so on, but the present invention is not limited to these apparatus. Alternatively, the internet connected digital photo frame 10 is also coupled with a video apparatus or an audio player (not shown in the figure) for receiving an audio file or network broadcast. Accordingly, the internet connected digital photo frame 10 may be used as a center or backup apparatus of digital photos at the local site for digital photos integration. If the internet connected digital photo frame 10 includes the function of control management, it further manages any actions relevant to social contact service. At a remote site, various internet connected digital photos belonging to other people may be stored in or acquired from different information centers 22 and 24, IP camera 18, different internet connected digital photo frames 26 and 28 or a mobile phone 30. The information centers 22 and 24 may provide various platforms to display digital information, such as a storage system for providing the web photo service.

Other people aforementioned are the people belonging to a relevant group and users for the user at the local site, such as the user's relatives, friends or people having similar hobbies. Under such a configuration, a portal website for digital photos groups 32 is configured for a social contact service system among the internet connected digital photo frames 10, 26 and 28, mobile phone 30, IP camera 18 and information centers 22, 24 and establishes the interactions among them. For example, when the relatives at the remote site capture digital photos with their mobile phones 30 or IP camera 18, they may upload the digital photos to the web photos of the information center 22 or 24 via link of the mobile phones and network, or directly link to the portal website for digital photos groups 32. The user at the local site may be notified via the portal website for digital photos groups 32 and further determine whether he or she directly views or downloads the digital photos.

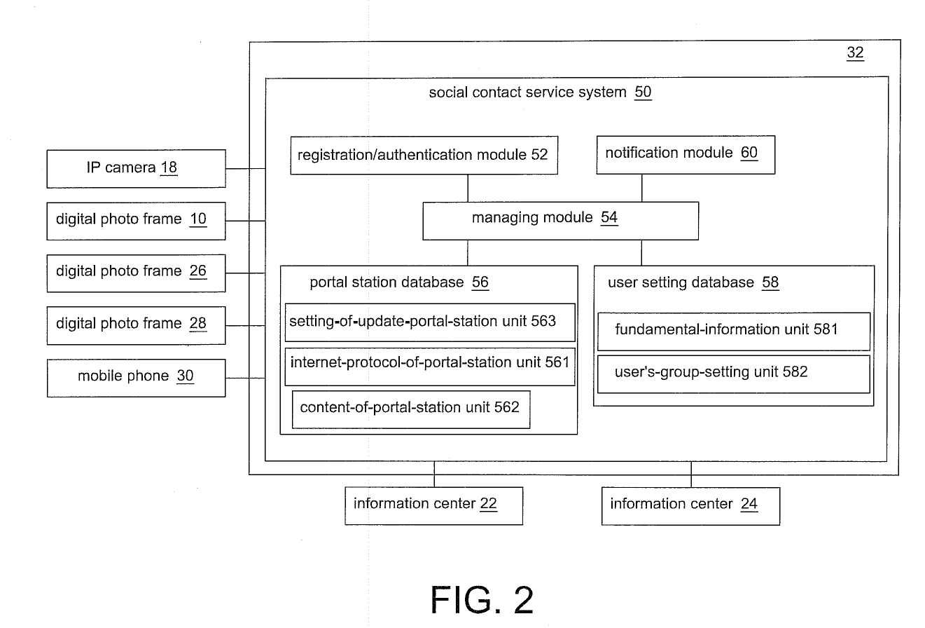

FIG. 2 is a schematic diagram illustrating a social contact service system of a portal website for digital photos groups in accordance with the present invention. The social contact service system 50 provided by the portal website for digital photos groups 32 includes a registration/authentication module 52, a managing module 54, a portal station database 56, a user-setting database 58 and a notification module 60. The social contact service system 50 is coupled with the internet connected digital photo frames 10, 26 and 28, IP camera 18, mobile phone 30 and information centers 22 and 24. In an embodiment, the registration/authentication module 52 enables users to apply, input registrations for authentication and set customized contents. Furthermore, the registration/authentication module 52 receives and transmits the registrations to the managing module 54 for sequential processes. The registrations include but not limited to a user's name, password and e-mail, pin (personal identification number) and so on. In a preferred embodiment, when the user's internet connected digital photo frame has been registered and authenticated, it may be assigned the internet protocol to the user or a unit identification code for the user's internet connected digital photo frame. The unit identification code may be directly used as the registration for the user to simplify the registering/authenticating step. Next, the user-setting database 58 stores the settings relevant to the users, and the portal station database 56 stores the settings relevant to portal stations set by the users. In the embodiment, the customized contents include the user's favorite portal stations. The portal stations in the internet-protocol-of-portal-station unit 561 are from but not limited to portal web service of, social media, social network service, web photo service, podcast or the combinations thereof. The contents provided by the portal station s include weather forecast, finances management, stock market news, flash news, top products, web photos, video and audio information, advertisement for sales promotion, or the combinations thereof. Moreover, application utilities and software may be provided herein, such as widget managing utilities provided by Yahoo or Google, dashboard managing utilities by a commercial operating system, gadget managing utilities by Microsoft Corporation under the trademark Vista or the combinations thereof. A setting-of-update-portal-station unit 563 is configured for providing the internet connected digital photo frame with a timer setting.

Next, the managing module 54 is configured for analyzing the registration and the customized contents from the registration/authentication module 52. The managing module 54 searches for the registration in the fundamental-information unit 581 of the user-setting database 58 to determine whether the user registration is existed or the user's updated information is retrieved. Furthermore, the managing module 54 searches for the registration in the user's-group-setting unit 582 to determine whether a match of the updated information of the group containing the user will be retrieved, such as the updated information from the grouping digital photo frames 26 and 28, IP camera 18 and the mobile phone 30.

For the analysis of the customized content settings, the managing module 54 searches for the customized content settings in the setting-of-update-portal-station unit 563 of the portal station database 56 to retrieve the user's timer settings and the updated status of the portal station contents, such as the notification for updated content from the information centers 22 and 24. Then the managing module 54 retrieves updated contents from the internet-protocol-of-portal-station unit 561 and the associated content-of-portal-station unit 562. The updated contents retrieved by the managing module 54 may be updated weather, updated news, updated traffic, video or updated advertisement. Furthermore, according to the registration and the customized content settings at preset time, the managing module 54 transmits the associated content settings and updated contents to the notification module 60 which then further transmits them to the internet connected digital photo frames 10, 26 and 28 or mobile phone 30.

It is noted that, in addition to the social contact service system 50, the portal website for internet connected digital photos groups 32 may provide some typical service systems that are not further illustrated therein. Accordingly, via linking to the portal website for internet connected digital photos groups 32, the users use the internet connected digital photo frames 10, 26 and 28 or mobile phone 30 to know whether there is any information updated by one or more belonging groups at the remote site. For example, after dates, friends or relatives may share updated photos to other in the belonging group via the portal website for internet connected digital photos groups 32. Thus, the internet connected digital photo frames together with the portal website for internet connected digital photos groups 32 establish a social contact co-generation system. In addition to sharing digital information among the groups, the portal website for internet connected digital photos groups 32 may provide the groups with the advertisement services to benefit the portal website for digital photos groups 32. Next, the social contact service system may provide the customized latest information at suitable time preset by the user if necessary. The customized latest information may be weather forecast, finances management, stock market news, flash news, top products, web photos, video and audio information, advertisement for sales promotion, or the combination thereof. Furthermore, on the condition of the capability to control and manage, the digital photo frame 10 may update the customized content settings or manage the groups' digital information via the social contact service system 50.

Although the present invention has been explained in relation to its preferred embodiment, it is to be understood that other modifications and variation can be made without departing the spirit and scope of the invention as hereafter claimed.

What is claimed is:

1. A social contact service system of internet connected digital photos comprising a managing module coupling with a registration/authentication module, a notification module, a portal station database and a user-setting database, the improvement comprising:
the registration/authentication module receiving a registration and a customized content settings from a user, and transmitting the registration and the customized content settings to the managing module;
the managing module searching for the registration in the user-setting database to determine whether an updated information of a group containing the user is retrieved, and searching for the customized content settings in the portal station database to retrieve an updated content associated with the customized content settings; and
the notification module transmitting the updated information and the updated content from the managing module to the user.

2. A social contact service system of internet connected digital photos according to claim 1, wherein the registration includes an internet protocol for the user.

3. A social contact service system of internet connected digital photos according to claim 1, wherein the registration includes a unit identification code for the user.

4. A social contact service system of internet connected digital photos according to claim 3, wherein the unit identification code belongs to an internet connected digital photo frame.

5. A social contact service system of internet connected digital photos according to claim 1, wherein the customized content settings comprises a plurality of settings of favorite portal stations for the user, and the favorite portal stations are from portal websites, social media, social network service, web photo service, podcast or the combinations thereof.

6. A social contact service system of internet connected digital photos according to claim 5, wherein the customized content settings further comprises a plurality of application utilities for the user, and the application utilities are widget managing utilities, dashboard managing utilities, gadget managing utilities or the combinations thereof.

7. A social contact service system of internet connected digital photos according to claim 1, wherein the portal station database comprises a setting-of-update-portal-station unit for providing the user with a timer setting and a status of updated portal stations.

8. A social contact service system of internet connected digital photos according to claim 7, wherein the portal station database further comprises an internet-protocol-of-portal-station unit and an associated content-of-portal-station unit for retrieving the updated content.

9. A social contact co-generation system, comprising:
a portal website for a digital photo group, comprising a social contact service system, wherein the social contact service system comprises a managing module coupling with a registration/authentication module, a notification module, a portal station database and a user-setting database; and
a plurality of internet connected digital photo frames respectively linking the portal website for becoming the digital photo group via the portal website;
wherein, when any of the internet connected digital photo frames links the portal website, the registration/authentication module receives a registration and customized content settings from any of the internet connected digital photo frames, and transmits the registration/authentication and the customized content settings to the managing module;
the managing module searches for the registration in the user-setting database to determine whether an updated information of the digital photo group containing the internet connected digital photo frame is retrieved, and searches for the customized content settings in the portal station database to retrieve an updated content associated with the customized content settings; and
the notification module transmits the updated information and the updated content from the managing module to the linking internet connected digital photo frame.

10. A social contact co-generation system according to claim 9, wherein the registration includes an internet protocol of the linking internet connected digital photo frame.

11. A social contact co-generation system according to claim 9, wherein the registration includes a unit identification code.

12. A social contact co-generation system according to claim 9, wherein the customized content settings comprise a plurality of settings of favorite portal stations, and the favorite portal stations are from a portal website, social media, social network service, web photo service, podcast or the combinations thereof.

13. A social contact co-generation system according to claim 9, wherein the portal station database comprises:
a setting-of-update-portal-station unit for providing the linking internet connected digital photo frame with a timer setting and a status of updated portal stations; and
an internet-protocol-of-portal-station unit and an associated content-of-portal-station unit for retrieving the updated content.

14. A social contact co-generation system according to claim 13, wherein the associated content-of-portal-station unit has a updated content of weather forecast, news, updated traffic recording, updated advertisement, application utilities or the combination thereof.

15. A social contact co-generation system according to claim 13, wherein the customized content settings comprise a plurality of settings of favorite portal stations for the user, and the favorite portal stations are from a web service of portal website, social media, social network service, web photo service, podcast or the combinations thereof.

16. A social contact co-generation system, comprising:
a portal website for a digital photo group, comprising a social contact service system, wherein the social contact service system comprises a managing module coupling with a registration/authentication module, a notification module, a portal station database and a user-setting database; and
a plurality of internet connected digital photo storages respectively linking the portal website for becoming the digital photo group via the portal website;
wherein, when any one of the internet connected digital photo storages links the portal website, the registration/authentication module receives a registration and a customized content settings from any one of the internet connected digital photo storages, and transmits the registration and the customized content settings to the managing module;
the managing module searches for the registration in the user-setting database to determine whether an updated information of the digital photo group containing the linking internet connected digital photo storage is retrieved, and searches for the customized content settings in the portal station database to retrieve, in the portal station database, an updated content associated with the customized content settings; and
the notification module transmits the updated information and the updated content from the managing module to the linking internet connected digital photo storage.

17. A social contact co-generation system according to claim 16, wherein the digital photo storage is an internet connected digital photo frame, a mobile phone, a web photo storage or the combination thereof.

18. A social contact co-generation system according to claim 16, wherein the customized content settings comprise a plurality of settings of favorite portal stations for the user, and the favorite portal stations are from a portal website, social media, social network service, web photo service, podcast or the combinations thereof.
